(19) United States
(12) Patent Application Publication
(10) Pub. No.: US 2010/0245581 A1
(43) Pub. Date: Sep. 30, 2010

(54) WARNING DISPLAY SYSTEM

(75) Inventors: Yuu Koyama, Suginami-ku (JP); Takashi Yamaguchi, Matsudo-shi (JP)

Correspondence Address: LEE FREDRIC SHARRA, 4313 TROUTHAVEN DRIVE, MURRYSVILLE, PA, 15668, US

(73) Assignees: Yuu KOYAMA, Suginami-ku, Tokyo (JP); Shinichi SAKAMOTO, Wako-shi, Saitama (JP); Takashi YAMAGUCHI, Matsudo-shi, Chiba (JP); Natsuko KATO, Chiyoda-ku, Tokyo (JP); Takako NAKAI, Kawasaki-shi, Kanagawa (JP)

(21) Appl. No.: 12/522,190

(22) PCT Filed: Jan. 9, 2008
(86) PCT No.: PCT/JP2008/050126

§ 371 Date: Jul. 6, 2009

(30) Foreign Application Priority Data
Jan. 11, 2007 (JP) 2007-003542
Feb. 16, 2007 (JP) 2007-036867

(51) Int. Cl. H04N 7/18

(52) U.S. Cl. 348/149; 348/E07.085

(57) ABSTRACT

The purpose of this invention is to provide a warning display system on which a warning from an emergency vehicle is displayed as letters. When an emergency vehicle emits letter information of ‘please leave the left traffic lane’ by acoustic watermarking (electronic watermarking) together with siren sound on a congested expressway, among general vehicles, vehicles driving on a left lane and having devices capable of receiving the information in a range in which sound can reach change the lane to a center lane. Because among the general vehicles, vehicles driving on the center lane and having devices capable of receiving the information allow vehicles traveling on the left lane to move to the center lane, the left lane becomes empty and the emergency vehicle can smoothly drive on the left lane.

### CROSS REFERENCE TO PRIOR APPLICATIONS

This application is a U.S. National Phase Application under 35 U.S.C. §371 of International Patent Application PCT/JP2008/050126 filed on Jan. 9, 2008 and claims benefit of Japanese Application No. JP2007-003542 filed in the Japanese Patent Office on Jan. 11, 2007, and Japanese Application No. JP2007-036867 filed in the Japanese Patent Office on Feb. 16, 2007 and issued as Japanese Patent No. 4024285 on Nov. 6, 2008, the entire contents of which are incorporated herein by this reference. The International Application was published in Japanese on Jul. 17, 2008 as International Publication No. WO/2008/084804 A1 under PCT Article 21(2).

### FIELD OF THE INVENTION

This invention relates to a warning display system between emergency vehicles and general vehicles.

### BACKGROUND OF THE INVENTION

Emergency vehicles, such as a fire trucks, police cars, and ambulances, announce their presence by sounding a siren to surrounding vehicles about being in an emergency situation and their need to have an open path on the road.

Japanese Patent Application Publication No. 2006-220435 (JP2006-220435) describes a navigation system, this navigation system has a voice information means by which a voice reports a variety of information to a crew member, a microphone which detects a peripheral sound of vehicles, a judge means whether the sound which gathered sound with the microphone is a siren of an emergency vehicle, an information control means which increases the volume of voice information, when judged that the gathered sound being a siren of the emergency vehicle.

Japanese Patent Application Publication No. 2002-196788 (JP2002-196788) describes an audio device, which lowers volume automatically, when warning sound of sirens, such as an emergency vehicles, or a crossing gate is perceived.

Japanese Patent Application Publication No. 2000-156049 (JP2000-156049) describes a radio with CD player, capable of displaying the song name and artist name information that is superimposed on the music, utilizing the audio watermark (called digital watermarking) technology on which character data is superimposed on the sound which is broadcast over the radio airwaves.

### SUMMARY OF THE INVENTION

As described in JP2006-220435 and JP2002-196788, the sound of emergency vehicle sirens is detected, and volume of voice information means is enlarged, or audio device volume is made small. If the driver listening to music using earphones or the driver is a hard-of-hearing person, the driver can not hear the siren.

In addition, even if the driver of the vehicles which run the front is listening to music using the earphone, increasing the siren volume by such an extreme may cause the driver to be able to audible hear the siren however the driver may also become surprised on the contrary, and make a mistake in steering and cause an accident. Furthermore, increasing the volume at night becomes a neighborhood nuisance.

Even if a siren can be heard, there is no telling in what way the driver of the vehicles which run the front is good. As a result, commonly, the driver may stop his car in that position and thereby interfere with the travel and course of the emergency vehicles.

Regarding JP2000-156049, no relationships with emergency vehicles is made at all. And there is no indication or suggestion carried out.

This invention is provided to solve the problems presented in prior art presented above. This invention is a warning display system between an emergency vehicle and general vehicle, wherein the emergency vehicle is equipped with a speaker. The speaker transmits sound to which specifics character data has been assigned to the specific audio wavelength. An alternate system where the specific character data is assigned to the specific wavelength sound; and this sound is superimposed over another sound and the speaker transmits the superimposed sound.

The above general vehicles are equipped with navigation system. This navigation system is equipped with the microphone which receives the sound sent from said speaker, and the navigation system translates the received sound to specific character data, and displays the specific character data.

Any capable wavelength frequency band can be assigned to superimpose character data on a warning sound. Specifically, part wavelength band of a warning sound is assigned and transposed to character data. It is the usual aspect of this invention that the character data is superimposed and sent with a warning sound. If it is used by police vehicles, without sounding a siren, it is considered to obtain cooperation with the surrounding cars. In such a case, to character data is assigned to the sound of high frequency zone which people cannot recognize as a voice, and sends only the voice of this specific wavelength zone.

Regarding this display, it is possible to utilize navigation systems displays. In this case, even if it is displaying the map during driving, it is preferable to give priority over this the display and to the display the character data of a warning the display.

Furthermore, since an emergency vehicles run at high speeds of about 100 km/h in an emergency, its relative velocity difference with the vehicles which are driving in front is large. For this reason, when transmitting to forward vehicles, the use of high frequencies may be applied with compensation beforehand so that the emergency vehicle takes into account the Doppler Effect.

According to the warning display systems of this invention, it is not only a siren that enables the general vehicle drivers to recognize an emergency situation exists. Since warns from emergency vehicles are also displayed as character data, emergency awareness becomes higher than before.

Moreover, since this system not only can transmit character (text) information about the emergency to general vehicle drivers, it is not merely able to inform that an emergency has arisen, but it can give instructional information, for example: “please vacate the left side of road”, or “turn to the right”. Therefore, general vehicle drivers can appropriately judge how to yield the road in a way so as not to interfere with the emergency vehicles. As a result, a shortening of the arrival time to the fire area, the scene of an accident, or a hospital can be achieved.

Moreover, character data is transmitted as a sound. As a result, the reaching distance is extremely restricted and cannot cause conflict with other communications. Therefore, the invention does not violate radio transmission laws.

Most general vehicles which are targeted to receive and display characters data presently carry navigation systems. Therefore, as a display which displays characters data, if navigation systems displays are utilized, the front part of dashboard is effectively utilized.

In addition, the following is possible. Emergency vehicles equipped with a speaker to transmit the sounds, the signal in which assigned character data is allocated to the sound can be set to a specific wavelength zone. The above mentioned general vehicles equipped with a microphone to receive the allocated signal, display the character data after extracting the character data from the above mentioned received allocated wavelength sound.

### BRIEF DESCRIPTION OF THE DRAWINGS

FIG. 1 Concept drawing the warning display system concerning invention, (a) is a bird's-eye view showing the state of the highway before emits an alarm, (b) is a bird's-eye view showing the state of the highway after emits an alarm.

FIG. 2 Circuit composition figure of emergency vehicle.

FIG. 3 Circuit composition figure of general vehicle.

FIG. 4 detailed explanation of the circuit composition of the emergency vehicle of system.

FIG. 5 Detailed explanation of the circuit composition of the emergency vehicle of a digital-watermarking system.

FIG. 6 Example of a data packet format of the digital-watermarking system.

FIG. 7 Principle figure which carries out continuation reception of same data two or more times, and carries out comparison correction.

FIG. 8 Example using the navigation system by coding control.

### DETAILED DESCRIPTION OF THE INVENTION

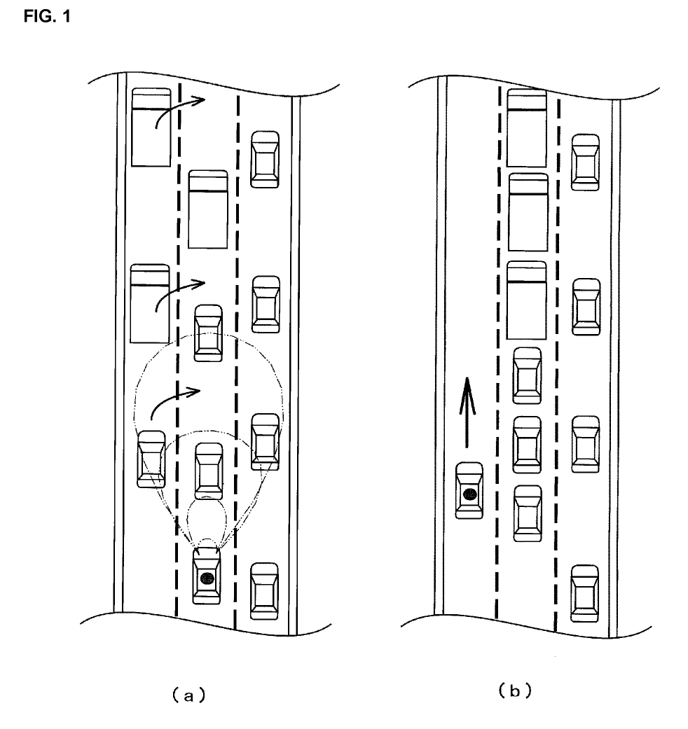

In the following, embodiments of this invention will be explained with reference to the drawings. FIG. 1 is a concept drawing depicting the warning display system of the present invention where (a) is a bird's-eye view showing the state of the highway before an alarm is emitted and (b) is a bird's-eye view showing the state of the highway after an alarm is emitted, and FIG. 3 shows circuit composition figures for general vehicles.

First when explaining the circuit composition figure for an emergency vehicle, basically, the circuit comprises a power supply 1, a switch 2, a siren sound generation part 3, a sound generator region 4 wherein character data is assigned and encoded, correction circuits 5, and a speaker 6.

Hereinafter, character data refers to a characters data group. This character data group is preserved in the device by at least one or more character data group or default input directly with the following keyboards K. Furthermore, the character set of data input from the outside of a network is also included.

The sound generation region 4, in which character data is assigned, has two functions. When a specific letter is input with touch-tone system, the letter with which it corresponds is converted by function to the specific wavelength band. The function memorizes the converted content. The conversion methods, which convert the specific wavelength bands to sound, are as follows. For example, the sound of 8000 to 8010 Hz is assigned about a character “ [symbol] ”, the sound of 8010 to 8020 Hz is assigned about “ [symbol] ”, the sound of 8050 to 8060 Hz is assigned about “A”, and it outputs from a speaker 6 together with the sound of siren generated in the siren sound generation part 3. Character data allocates specific wavelength bands as aforementioned about hiragana, katakana, numbers, letters and major Chinese characters, and this assignment is uniform on the sending and the receiving sides.

For example, the character “open the left lane” is entered. And then, the sound of the wavelength zone equivalent to each character is assigned, and the combination of the sound of this wavelength zone is memorized. Some display patterns are input in advance, and are memorized, and thus the most appropriate one is selected at the time, it superimposes on sound of siren, and a character is sent from a speaker 6 on the emergency vehicle side. In addition, one may send separately siren sound and the sound corresponding to character data from a speaker 6.

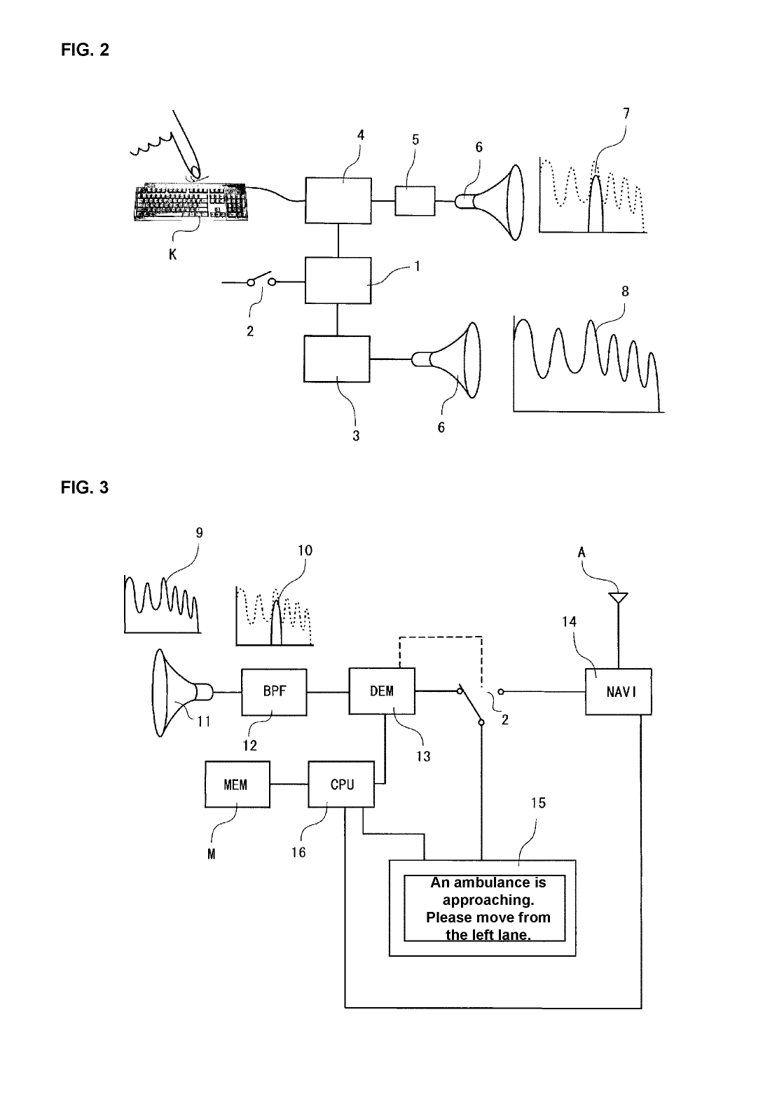

FIG. 2 explains the manner in which the composite tone is assembled where the composite tone includes the siren sound and a sound corresponding to character data superimposed before. In addition, also in each embodiment, it is generally essential to use a means to clarify a communications period using the start signal which informs the start of data transmission, and the termination signal which informs end of data transmissions.

At the time of disclosure, for the aforementioned start signal and end signal, it is possible to use a simple start/stop type code as used, for example, by infrared remote control communication for televisions, etc.

FIG. 2 shows detailed explanation of the circuit composition of the emergency vehicle of a touch-tone phone type system. In this example, at least one character data is input from keyboard K, and generates the assigned sounds 7a assigned to this character data by the sounds generation region 4 similar to a touch-tone phone. With a mixer 31, the assigned sound 7a is mixed with the sound of the corrected siren 8a generated in the siren sound generation part 3, and the mixed sound is output from a speaker 6. The sound of corrected siren 8a is a sound in which the frequency ranges of sound 7a are removed from the sound of siren 8. In this embodiment, the a single frequency is assigned to sound 7a so that it may be easy to understand, but when the frequencies assigned sound 7a are multiple, all the regions of the assigned frequencies in sound 7a need to correct the sound of siren 8a by omit these peaks.

In this way, the sound output as loudspeaker output sound 32 is a composite waveform of siren 8a and sound 7a.

In this case, for example, the PIC microcomputer of Microchip Technology Inc., or the AVR microcomputer of ATMEL Inc. can be used, the switch where the keyboard signal enters is detected and depending on what you encode, it converts to the signals from the pushed keys and it makes serial data output. Furthermore, if data watermarking processing is performed to the above-mentioned key scan code, a watermarking sound signal will be generated.

Furthermore, if an error correction means is added to the sound signaling which embeds the character data by digital watermarking, when the sound from said speaker 6 is received, reflection, interference of the acoustic frequency character, etc. enable it to display correct character in the range which can carry out error correction, even if an error arises to reproduction data.

Moreover, in the correction circuits 5, compensation taking into account the speed of the emergency vehicle is performed. That is, if emergency vehicles run at high speeds and approach forward the general vehicle, the Doppler Effect will cause the general vehicle to receive the sound of frequency higher than the wavelength which the emergency vehicles sent. As a result, there is a possibility of such assignment being out of order, and displaying mistaken characters data. So, in the correction circuits 5, the sound corresponding to the character data sent is rectified according to the ambulances speed and sent to the low frequency side. In the case of using the character data from the emergency vehicle, the state where the road is hidden due to congestion of general vehicle is a case thought about most. Therefore, compensation will become simple to rectify if one considers that the speed of the general vehicle which run the front is zero.

Moreover, it is possible in siren sound generation part 3 to send the specific wavelength sound converted by inputting a prescribed character with at least one standard frequency sound.

In the above-mentioned, the stopped car and the car in movement can receive the correct allocation frequency only if the correction circuit 5 periodically shuffles the sound when the above-mentioned standard frequency becomes a predetermined frequency is picked up.

Moreover, when it is a receiver and receives, without using the correction circuits 5, returning to a specific wavelength zone sound changed above-mentioned is also considered by carrying out inverse transformation of the sound frequency such standards to default frequency.

A similar method to the touch-tone telephone is encoded as the above-mentioned example. For example, the character “ [symbol] ” is sent on the frequency of 8000 to 8010 Hz after a 7500 Hz references signal, and “ [symbol] ” is sent on the frequency of 8010 to 8020 Hz, and “A.” is sent on the frequency of 8050 to 8060 Hz. As a result, if the following sound is the frequency which is 8000 to 8010 Hz, “ [symbol] ” is detected, if the following sound is the frequency which is 8010 to 8020 Hz, “ [symbol] ” is detected, and “A” is detected if it is the frequency is 8050 to 8060 Hz.

FIG. 3 shows circuit diagram of general vehicle. The circuitry of the general vehicles consists of a Microphone 11, a Filter 12, the Conversion Part 13 to convert from a sound to a character, Navigation System 14, a Display 15, a CPU 16 which controls the system, and Memory M which save each configuration value, etc.

Among the sounds which are received with the microphone 11, the sound of a predetermined wavelength zone passes a Filter 12 as select range 10, is converted into the text accommodating to individual wavelengths in the Converter 13, and is displayed on the Display 15 of Navigation System 14.

When the Converter 13 determines that given character data is received, a signal sent to CPU 16 of Navigation System 14, to give priority to the character data changed from the audio in the Converter 13 to the character, and it is displayed on a Display 15.

What is necessary is just to add to the receiver with a references signals detection circuit and the frequency changing circuit which converts into default frequency the references signals frequency received in the PLL circuit etc., in assigning a character to certain frequency range and sending references signals and characters as a pair, as the circuit composition figure by the side of an emergency vehicle described.

Moreover, when keyboard serial data output is embedded in sound by digital watermarking, character data is renewable by decoding such serial data by using the PIC microcomputer of Microchip-technology Inc., or the AVR microcomputer of ATMEL Inc.,

In the above, for example, FIG. 1 (a) shows the state where congestion has occurred on the expressway. However, in this status, the emergency vehicles 20 sends the text information “open the left lane” by audio watermark (digital watermarking) with sound of siren. Then, the vehicles which are driving in the left lane among the general vehicles 30 which carry equipment which receives in the range which sound reaches change lanes into central lane. Moreover, the vehicles which are running the middle lane among the general vehicles 30 carrying the equipment for reception of the signal allow the vehicles which are running the left lanes to move into the middle lane. As a result, as shown in FIG. 1 (b), a left lane is opened and the emergency vehicle(s) can smoothly drive in the highway left lane.

In addition, since some vehicles which do not carry an installed reception system will also follow vehicles that carry such system on hearing the siren, so if the receiver equipment for general vehicles is carried on a number of those vehicles, in this case the same effect can expected.

Moreover, it is possible that the watermarking character data sent from said emergency vehicles communicates in frame formats with ID. Since correct characters are renewable if the watermarking noise which goes straight on extracts only the frame which can read ID and is reproduced by this even if reflective sound is mixed, the probability the sound is garbled becomes low. In addition, it becomes fail-safe to be able to prevent information being displayed in the car of the other side lane by mistake even by any chance.

Furthermore, making multiple types of compasses of digital-watermarking sound, mixing, and outputting is also considered. Since the complement of extracting characters data from the sound of compass with a sufficient received frequency character or data can be performed even if the environment outside a vehicle comprising outside air temperature changes by this, the probability which can reproduce a character correctly becomes high. This method embeds character data by making the compass from 1 to 3 kHz the first frequency band, 4 to 7 kHz the second frequency band, and 8 to 11 kHz the third band, and using the digital watermark by each bandwidth, and transmits the same character data at the same time.

As for the sound in which the digital watermark is buried, it may be embedded under an audible signal such as a siren, for instance, alternatively, the sound of the digital watermark alone may be transmitted without a corresponding sound.

Moreover, such characters data may be converted with ASCII code, and the character data as a digital signal may be converted into a sound signaling like the after-mentioned employing watermarking technology.

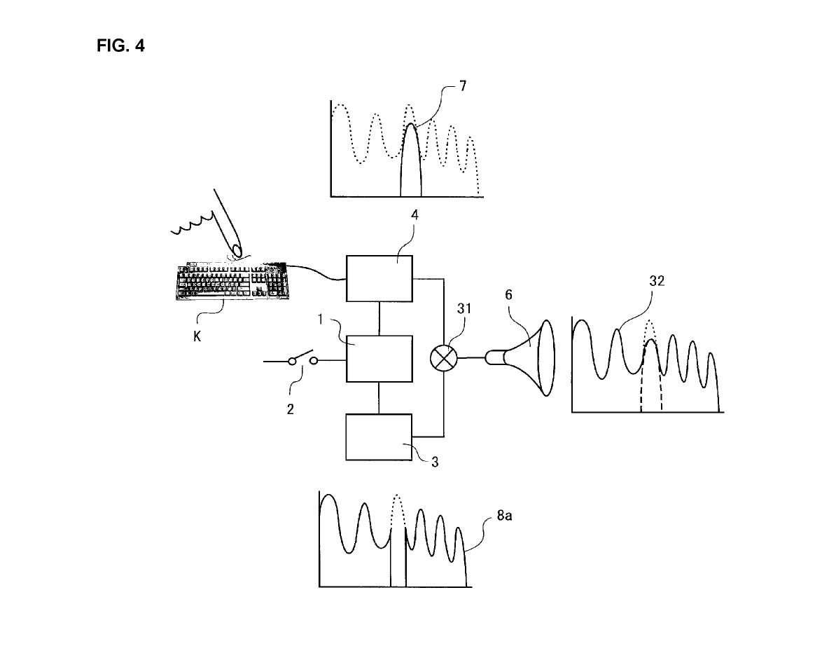

Also in this case, as depicted in FIG. 4, the sound of the siren and the sound signal which embeds such character data by digital watermarking are not sent from a speaker 6 separately. As appears in FIG. 2, a synthetic sound in advance superimposed on siren sound and the sound corresponding to character data is composed, and it is possible to send this synthetic sound.

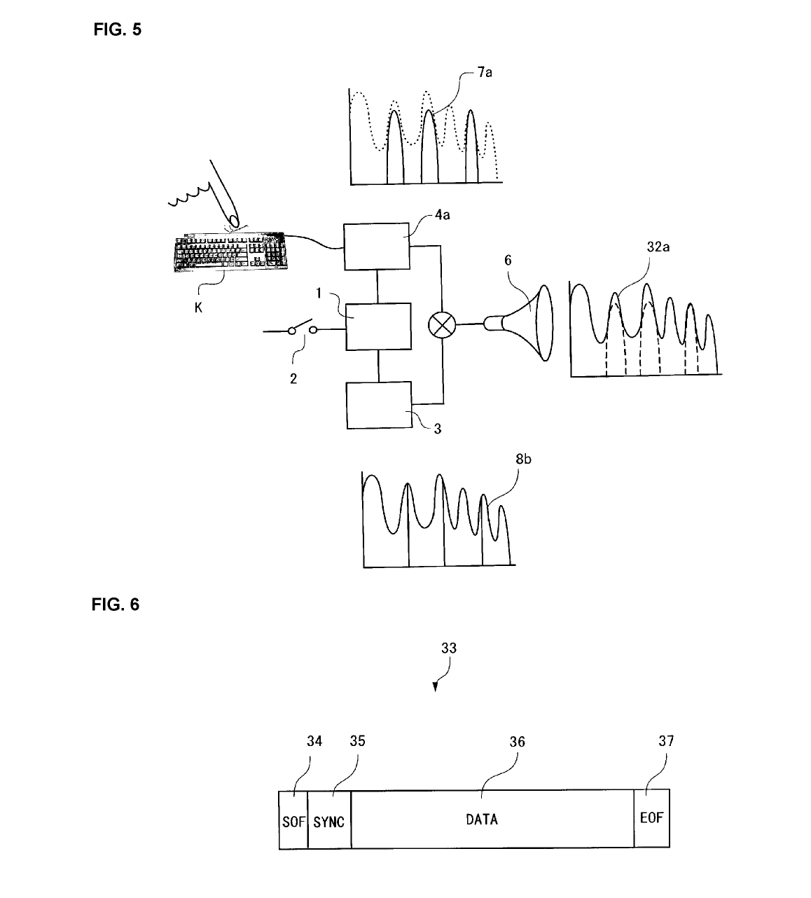

FIG. 5 shows detailed explanation of the circuit composition of the emergency vehicle of a digital-watermarking system. Differing from a precedent is the point of using the digital-watermarking sounds generation region 4a, substitute being the sounds generation region 4 to which characters data is assigned.

Since sounds said digital watermark generation region 4a has a predetermined limited frequency spectrum, after mixing with the sound of siren 8b excluding the limited frequency spectrum domain from the sound of siren 8 by a mixer 31, it is necessary to output it with a speaker 6.

FIG. 6 shows the example of a data packet format of the digital-watermarking system. In packet systems as above-mentioned, it is necessary to store the data received by the general vehicle in Memory M, once. However, it is stabilized regardless of the speed on the side of an emergency vehicle, and there is the benefit which is received.

The above-mentioned communication method is asynchronous type packet communication, and start data 34, control data 35, character data 36, and end data 37 are contained in data frame 33.

Network frame flag and address data are included in the start data 34.

In control data 35 there is control command values and frame protocol identification values, and packet communication is included in the control data 35.

The text information which is entered by the emergency vehicle is stored in the character data 36. However, since a text can be divided at two or more packets in the case of packets communications, long text can also be transmitted.

An inspection sequence data from an address to a part for a data division and a flag which point out the end of a frame are included in the end data 37 of a frame.

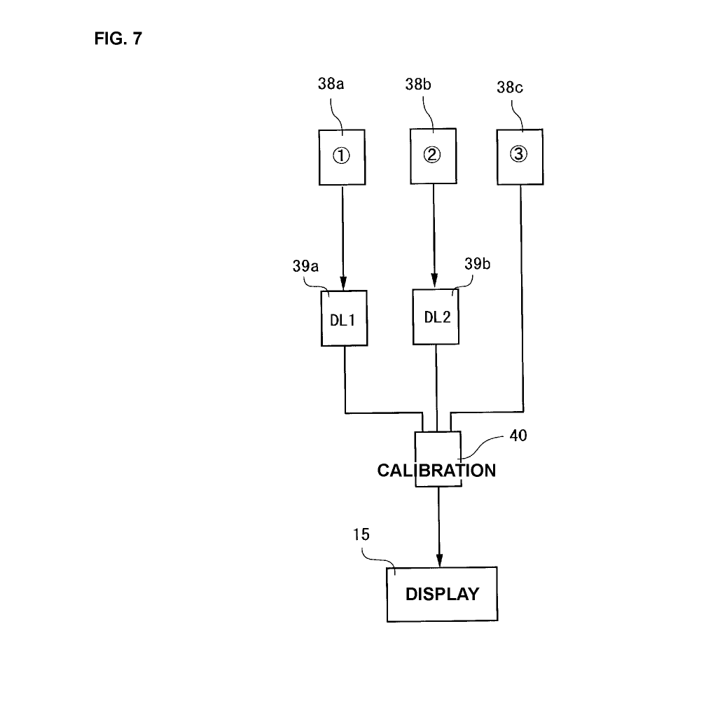

FIG. 7 shows the principle figure which carries out continuation reception of same data two or more times, and carries out comparison correction. 38a, 38b, and 38c are the characters data noise 7 sent from the speaker 6 by the same specification. The characters data information 38a reproduced from the microphone collection sound 9, is delayed in the delayed circuit 39a, and the characters data information 38b is delayed in the delayed circuit 39b, the characters data information 38c is straight inputted into the Comparison Calibration Circuits 40, and if it is decided by majority rule, a majority result is displayed as a recognition characters data on a Display 15. When not decided by majority votes, an error indication is displayed on above Display 15, otherwise it does not display at all.

The above depiction of multiple same data check circuit examples is the method of selecting the data which transmits two or more same data as a fail-safe means, compares these data, and is considered to be correct by majority rule. This method serves as a means effective in the data complement in packet communication.

Although the case where 3 sets of character data or a packet is used as explained here, number of data items is not limited to 3 sets, and 2 sets or at least 4 sets or more of same techniques can be used.

Although character data was handled as two or more continuous receiving sound in the said, in the above-mentioned example, for example, when the compass of the whole microphone collection sound 9 is divided into three and the same characters data is embedded with watermarking technology in each range, the characters data of three groups can be extracted. Therefore, you may input the character data of these three groups into the Comparison Calibrations Circuits 40 simultaneously. Naturally, the delay circuits 39a and 39b become unnecessary in this case.

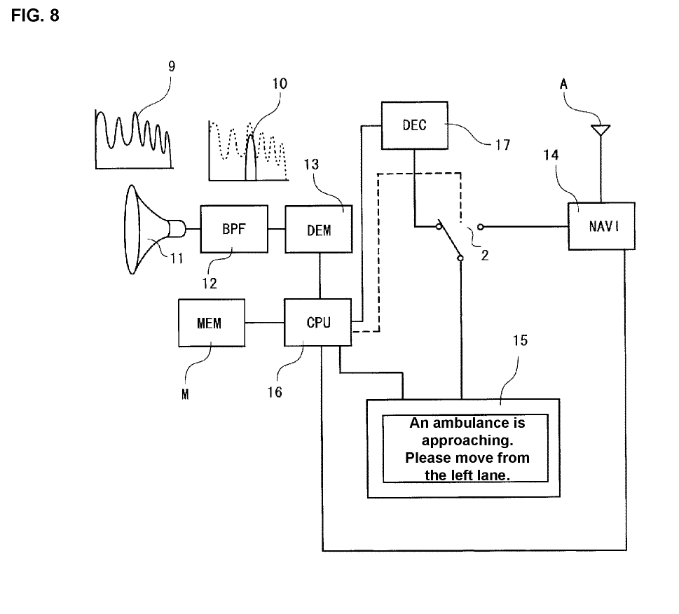

FIG. 8 shows the example using the navigation system by coding control. A predetermined display can be depicted on the display side according to a predetermined allocation signal even if the character-code is not sent and received if it decides it on the sending side and the reception side. In this case, the screen can be displayed in the above-mentioned navigation, and audio instruction assistance can be executed according to the embedded allocation signal triggering the embedded commands in the navigation device. That is, an emergency vehicle is equipped with the speaker which sends the sound of a specific wavelength zone as a quota signal of the above-mentioned character code, and the above general vehicles are equipped with the microphone which receives said allocation signal, and the display which converts and displays the received above-mentioned quota signal on the display controls data.

Although the basics configurations to the converter 13 is the same as FIG. 3, CPU 16 must control decoder 17, and with the display data that displays the character data corresponding to an allocation the prescribed above-mentioned signal when a prescribed allocation signal in conversion part 13 is detected by CPU 16, the display data and the guide voice data that displays the character data corresponding to an allocation the prescribed above-mentioned signal are output from decoder 17 to display 15.

1-8. (canceled)

9. A warning display system between an emergency vehicle and general vehicles, The emergency vehicle equipped with a speaker,
The speaker capable of transmitting specific sounds having encoded character data,
The speaker transmitting a specific wavelength sound encoded with specific assigned character data, and/or having the sound superimposed over the other sound and transmitting the superimposed sound,
the general vehicles equipped with navigation system,
the navigation system equipped with a microphone to receive the encoded sound transmitted from the speaker, and the navigation system interpreting the received sound having specific character data, and displaying the specific character data.

10. A warning display system according to claim 1, wherein the specific wavelength sound is a sound which people cannot recognize as a voice.

11. A warning display system according to claim 1, wherein the navigation system has priority to display the character data of the alarm over other displays.

12. A warning display system according to claim 1, wherein the character data is superimposed on blast of a siren.

13. A warning display system according to claim 1, wherein the character data has identification and is formatted in frames.
